(19) United States
(12) Patent Application Publication
(10) Pub. No.: US 2016/0358272 A1
(43) Pub. Date: Dec. 8, 2016

(54) AIRLINE SEAT OPTIMIZATION FOR PASSENGER SHOULDER WIDTH AND SIZE

(71) Applicant: MasterCard International Incorporated, Purchase, NY (US)

(72) Inventor: Justin Xavier Howe, San Francisco, CA (US)

(21) Appl. No.: 14/731,492

(22) Filed: Jun. 5, 2015

(51) Int. Cl. G06Q 50/14; G06Q 10/02

(52) U.S. Cl. CPC G06Q 50/14; G06Q 10/02

(57) ABSTRACT

A system, method, and computer-readable storage medium configured to analyze the physical size of payment accountholders based on payment transactions, and allowing a transportation provider to apply the physical size of payment accountholders to seating.

### BACKGROUND

### Field of the Disclosure

Aspects of the disclosure relate in general to financial services and travel. Aspects include a method and analysis platform to analyze the physical size of payment accountholders based on payment transactions, and more particularly to apply the physical size of payment accountholders to seating.

### Description of the Related Art

A payment card is a card that can be used by a cardholder and accepted by a merchant to make a payment for a purchase or in payment of some other obligation. Payment cards include credit cards, debit cards, charge cards, and Automated Teller Machine (ATM) cards. Payment cards provide the clients of a financial institution (“cardholders”) with the ability to pay for goods and services without the inconvenience of using cash.

In a different industry, travelers purchasing airline and rail tickets are offered a limited choice of seating possibilities. Typically, passengers can choose the class of travel (first, business, or economy), a row within a cabin (forward or rear cabin), left or right side, and a seating location (window, middle or aisle) within the row. Some transportation providers charge extra for particular seats within a class, such as seats with extra leg room or exit-row seats.

### SUMMARY

Embodiments include a system, device, method and computer-readable medium to analyze the physical size of payment accountholders based on payment transactions, and more particularly to apply the physical size of payment accountholders to travel seating determination.

In a method of estimating passenger size, a network interface receives transaction data from a merchant bank. The transaction data includes a primary account number (PAN) associated with a customer and addenda for the transaction data. The addenda describe an apparel purchase, and include apparel detail. A processor extracts the primary account number from the transaction detail and the apparel detail from the addenda. The processor matches the primary account number with account information stored in a database. The database is encoded on a non-transitory computer-readable storage medium. The processor estimates a physical size of an individual associated with the primary account number based on the apparel detail. The database stores the physical size of the individual associated with the primary account number in the account information.

### BRIEF DESCRIPTION OF THE DRAWINGS

FIG. 1 is a block diagram illustrating a financial transaction involving an apparel or transportation purchase using a payment network.

FIG. 2 is an expanded block diagram of an exemplary embodiment of a server architecture of a payment network embodiment configured to analyze the physical size of payment accountholders based on payment transactions.

FIG. 3 illustrates a non-real time clearing process to analyze the physical size of payment accountholders based on payment transactions.

FIG. 4 illustrates a method of reporting the physical size of payment accountholders.

FIG. 5 illustrates an alternate method of reporting the physical size of payment accountholders.

### DETAILED DESCRIPTION

One aspect of the disclosure includes the realization that, for the comfort of their passengers, transportation providers should avoid seating physically large strangers next to each other. Transportation providers include airlines, railways, and bus lines. Potentially, transportation providers could simply ask passengers their physical size.

Another aspect of the disclosure is that methods of assigning variable seat width are possible.

However, another aspect of the disclosure is the realization that people are unlikely to accurately report their actual size. For example, some individuals purposefully represent that they are lighter than they are. (“I weigh less than 100 pounds.”) Others exaggerate their size. (“I am six-foot-four-inches tall.”)

A further aspect of the disclosure is the realization that an accountholder's physical size and height can be objectively approximated or determined by the size of clothing purchased. The size approximation can then be stored and sent to the transportation providers when requested or when a travel purchase transaction has taken place.

While embodiments described herein are applied to a travel context, it is understood by those familiar with the art that the concepts, apparatus, system and methods described herein may also be applicable to any context that requires the knowledge of the accountholder's physical size.

It is further understood that embodiments herein use accountholder Personally Identifiable Information (PII). It is further understood that the systems and processes described herein are intended to be carried out in accord with all applicable data usage and privacy laws and regulations. For example, in order to comply with such laws and regulations, accountholders may first need to be consent and opt into the use of their PII as set forth in the embodiments described herein.

The systems and processes are not limited to the specific embodiments described herein. In addition, components of each system and each process can be practiced independently and separately from other components and processes described herein. Each component and process also can be used in combination with other assembly packages and processes.

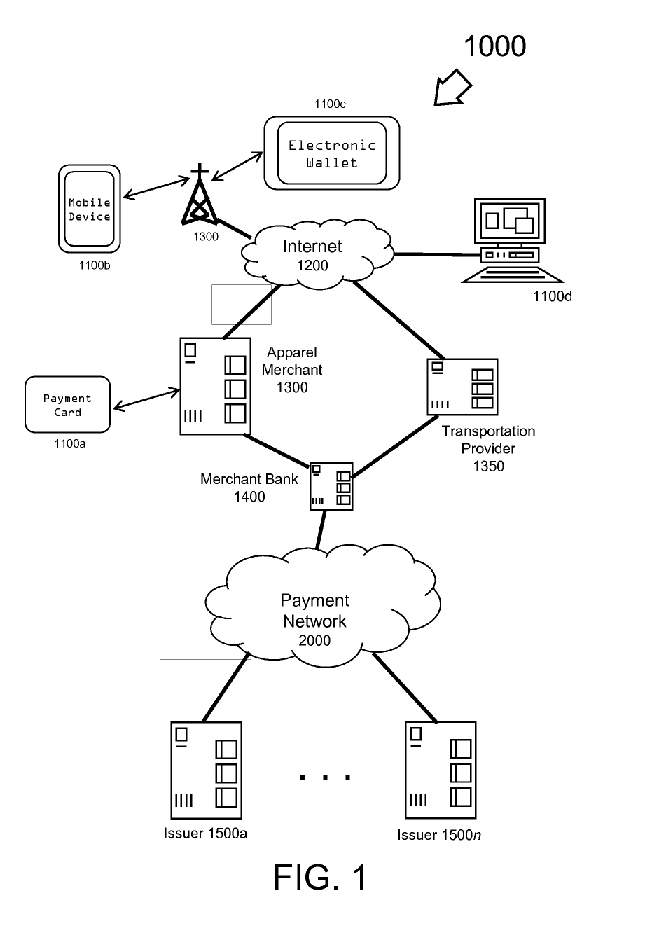

FIG. 1 is a block diagram 1000 illustrating a financial transaction using a payment device payment system involving an apparel or travel purchase. The present disclosure is related to a payment system, such as a credit card payment system using a payment network 2000, such as the MasterCard® interchange, Cirrus® network, or Maestro®. The MasterCard interchange is a proprietary communications standard promulgated by MasterCard International Incorporated of Purchase, N.Y., for the exchange of financial transaction data between financial institutions that are customers of MasterCard International Incorporated. Cirrus is a worldwide interbank network operated by MasterCard International Incorporated linking debit and payment devices to a network of ATMs throughout the world. Maestro is a multi-national debit card service owned by MasterCard International Incorporated.

In a financial payment system, a financial institution called the “issuer” 1500 issues a payment device to a consumer, who uses payment device 1100a-d to tender payment for a purchase from apparel merchant 1300 or transportation provider 1350. Payment devices may include a payment card 1100a, mobile device 1100b (such as key fobs, mobile phones, tablet computers, Personal Digital Assistants (PDAs) and the like), electronic wallets 1100c, or computers 1100d. Payment devices may be used to tender purchase in-person at apparel merchant 1300 or transportation provider 1350, or when connected via a mobile telephone network 1300 or the internet 1200.

In this example, a user presents the payment device 1100 to a point-of-sale device at apparel merchant 1300. The merchant is affiliated with a financial institution. This financial institution is usually called the “merchant bank” or the “acquiring bank” or “acquirer bank” 1400. When a payment device 1100 is tendered at apparel merchant 1300, the apparel merchant 1300 electronically requests authorization from the merchant bank 1400 for the amount of the purchase. The request is performed electronically with the consumer's account information. In payment cards, the consumer's account information may be retrieved from the magnetic stripe on a payment card 100a or via a computer chip imbedded within the card 1100a. For other types of payment devices 1100b-c, the consumer's account information may be retrieved by wireless methods, such as via near field communication (NFC). The account information is forwarded to transaction processing computers of the merchant bank 1400. Alternatively, a merchant bank 1400 may authorize a third party to perform transaction processing on its behalf. In this case, the apparel merchant 1300 will be configured to communicate with the third party. Such a third party is usually called a “merchant processor” or an “acquiring processor” (not shown).

The computers of the merchant bank 1400 or the merchant processor will communicate, via payment network 2000, with the computers of the issuer bank 1500 to determine whether the consumer's account is in good standing and whether the transaction is likely to be fraudulent. It is understood that any number of issuers 1500a-n may be connected to payment network 2000.

When a request for authorization is accepted, the available credit balance of accountholder's account is decreased.

After a transaction is captured, a clearing process occurs in which transactions are batch processed by payment network 2000, apparel merchant 1300, merchant bank 1400, and issuer 1500. During the clearing process, apparel merchant 1300 attaches addenda information to the transaction information. The addenda information may include the Stock Keeping Unit (SKU) of each of the items purchased. The SKU is a unique identifier for each distinct product and service offered by a merchant, and allows the payment network 2000 to determine the size of the clothing purchased. The clothing size allows payment network 2000 to determine the approximate physical size of the accountholder. Height is also correlated with shoe size, and can be approximated from the SKU purchase data for footwear.

The physical size of the accountholder may then be requested by a transportation provider 1350 during a travel transaction or provided after the transaction is being cleared.

Eventually, the transaction is settled between the apparel merchant 1300, the merchant bank 1400, and the issuer 1500.

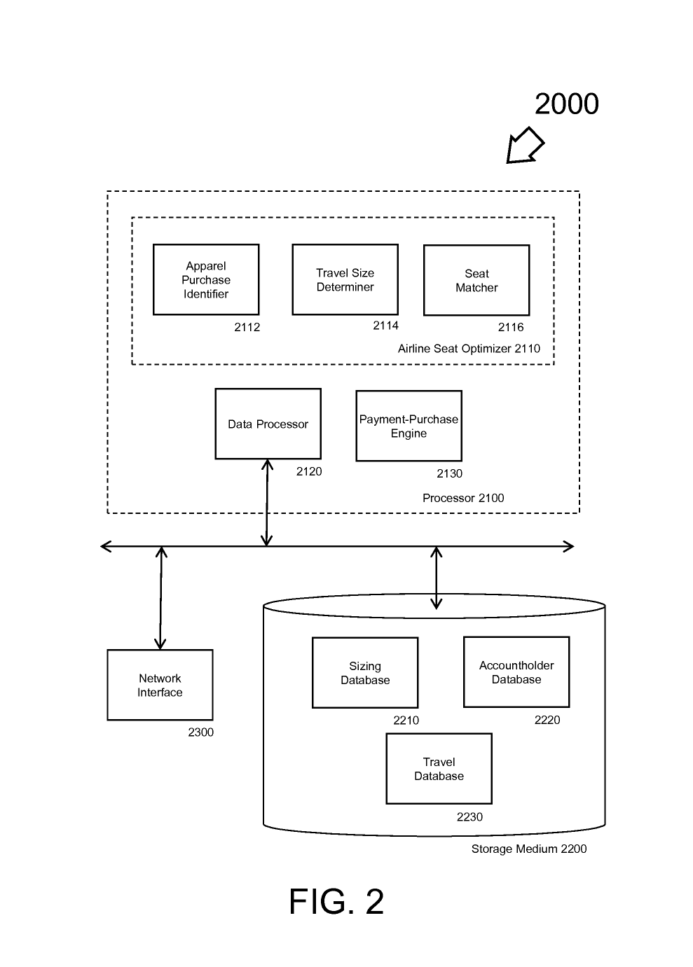

Embodiments will now be disclosed with reference to a block diagram of an exemplary payment network server 2000 of FIG. 2, configured to analyze the physical size of payment accountholders based on payment transactions, constructed and operative in accordance with an embodiment of the present disclosure.

Payment network server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of an airline seat optimizer 2110, a payment-purchase engine 2130, and a data processor 2120.

Data processor 2120 interfaces with Random Access Memory, storage media 2200 and network interface 2300. The data processor 2120 enables processor 2100 to locate data on, read data from, and writes data to, these components.

Payment-purchase engine 2130 performs payment and purchase transactions, and may do so in conjunction with airline seat optimizer 2110.

Airline seat optimizer 2110 is the structure that analyzes apparel purchase transactions to determine the physical size of accountholders, and may further comprise: an apparel purchase identifier 2112 and a travel size determiner 2114.

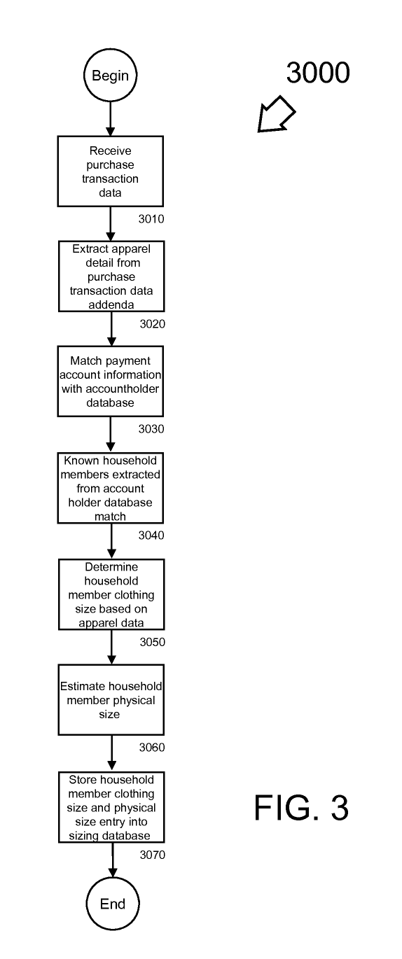

Apparel purchase identifier 2112 analyzes the addenda of financial transactions to determine apparel purchased by an accountholder. It is understood that other data sources may be used, such as merchant point-of-interaction (POI) data, SKU data cooperatives, cardholder receipts, and smart closets. From the apparel purchased by the accountholder, a clothing size may be deduced. Travel size determiner 2114 extrapolates the clothing size into an approximate physical size of the cardholder. Apparel purchase identifier 2112 and travel size determiner 2114 may store data related to accountholder size information in sizing database 2210. The functionality of both structures is elaborated in greater detail in FIG. 3.

Additionally, some embodiments of airline seat optimizer 2110 may also have a seat matcher 2116. In such embodiments, seat matcher 2116 uses the sizing information from the sizing database 2210 or travel size determiner 2114 to match the accountholder with an appropriate seat on an airplane, train, or any other form of transportation. Seat matcher 2116 may use itinerary, airline seat data, and other travel information stored in a travel database 2230.

These structures may be implemented as hardware, firmware, or software encoded on a computer readable medium, such as storage media 2200. Further details of these components are described with their relation to method embodiments below.

Computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage media 2200 may be remotely located from processor 2100, and be connected to processor 2100 via a network such as a local area network (LAN), a wide area network (WAN), or the Internet.

In addition, as shown in FIG. 2, storage media 2200 may also contain a sizing database 2210 an accountholder database 2220, and a travel database 2230. It is understood by those familiar with the art that one or more of these databases 2210-2230 may be combined in a myriad of combinations.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network server 2000 to communicate with apparel merchant 1300, transportation provider 1350, merchant bank 1400, and issuer 1500.

We now turn our attention to method or process embodiments of the present disclosure, FIGS. 3-5. It is understood by those known in the art that instructions for such method embodiments may be stored on their respective computer-readable memory and executed by their respective processors. It is understood by those skilled in the art that other equivalent implementations can exist without departing from the spirit or claims of the invention.

Embodiments create an accountholder sizing profile from apparel transactions to anticipate or aid seat selections on a travel itinerary on a transportation provider 1350.

FIG. 3 illustrates a process 3000 to analyze the physical size of payment accountholders based on payment transactions, constructed and operative in accordance with an embodiment of the present disclosure. Furthermore, process 3000 analyzes the purchase of apparel to extrapolate a physical size of a household member of the accountholder.

In such an embodiment, an accountholder purchases clothing from an apparel merchant 1300. The purchase may be made at a retail location, or as an on-line purchase. Additionally, the purchase may be made with a payment card 1100a or any other payment device known in the art.

Traditionally, a purchase made via payment card includes authorization, clearing and settlement processes. It is understood by those familiar with the art that process 3000 may be a non-real time clearing process, but in alternate embodiments may be a real time process. Conventionally, a clearing process is a non-real time process. As part of the clearing process of the present disclosure, apparel merchant 1300 sends the merchant bank 1400 details of the apparel purchase (the “transaction data”), such as the Primary Account Number of the payment account used in the transaction, date and time of the transaction, amount of the transaction and transaction addenda. The transaction addenda may include an SKU that uniquely identifies the apparel purchased. Alternatively, the transaction addenda may include the size or other indicia of the apparel purchased. In other embodiments, the apparel size information may be acquired through cardholder provided receipts, a merchant POI, or an SKU data cooperative.

At block 3010, payment network 2000 receives an apparel transaction data from the merchant bank 1400. The transaction data is received electronically via a network interface 2300, and may be part of data from many transactions received via a batch process.

Apparel purchase identifier 2112 extracts the apparel detail from the purchase transaction data addenda, block 3020. The SKU, size, or other indicia of the apparel purchase are extracted. In other embodiments, the apparel size information may be acquired through cardholder provided receipts, a merchant POI, or an SKU data cooperative.

Apparel purchase identifier 2112 matches the payment account information from the transaction with the appropriate entry in the accountholder database 2220, block 3030. This may be accomplished by matching the Primary Account Number of the payment account used in the transaction.

Each account entry in the accountholder database 2220 includes the known household members living with the accountholder. For example, the accountholder's household may include a spouse and children. The known household members are extracted from the accountholder database match, block 3040.

At block 3050, travel size determiner 2114 extrapolates and determines the household member clothing size based on the apparel data. For example, suppose the SKU indicates that a particular style of dress was purchased. The SKU can furthermore be used to determine the size of the dress purchased.

The travel size determiner 2114 can then use the size of the dress to estimate the household member's physical size, block 3060, including an approximate height, width, and weight of the household member. The travel size determiner 2114 can use sizing charts to estimate the physical size. For example, shoe size may be used to estimate height, as there is a correlation between shoe size and height. Additionally, other assumptions may be made, such as the number of people in a household, or repetitive size purchases over time are for a household member, while rarely purchased sizes are not for household members

At block 3070, the travel size determiner 2114 stores the household member clothing size and physical size entry into a sizing database 2210. Additionally, household profiles may be generated for each member of the household. For example, if the household includes a man, a woman and two identical twin-boys, the household profile would be represented from the apparel data as ‘an adult male’ profile ‘an adult female’ profile, and a ‘boy’ profile. As there is no way to distinguish which of the two boys a purchase is for, their profile may be included together.

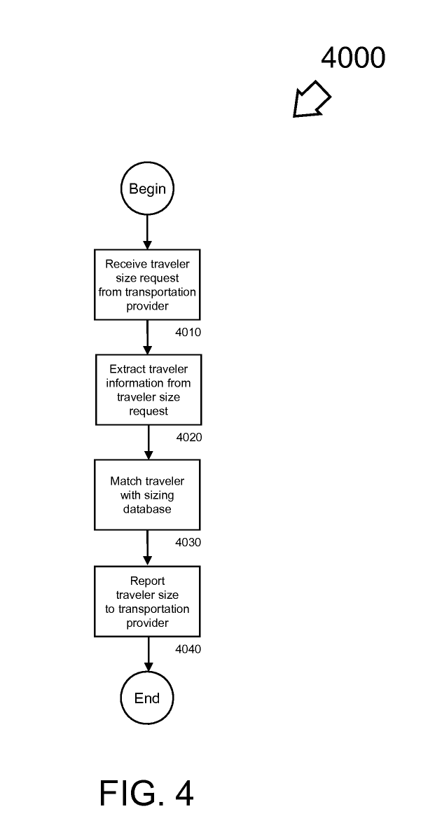

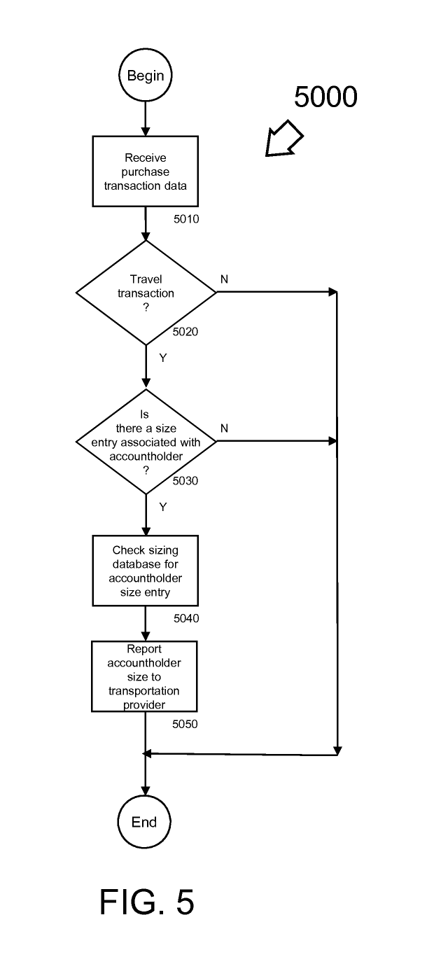

Once the household member or accountholder's physical size is stored in a sizing database 2210, the information may then be used by a transportation provider 1350 to factor in a passenger's physical size into their ticket sale or seating arrangements. In one embodiment described in FIG. 4, the transportation provider 1350 requests the physical size to be reported to them. Alternatively, FIG. 5 describes an embodiment where the payment network 2000 automatically reports the accountholder's physical size to the transportation provider 1350 after the purchase of travel by the accountholder.

FIG. 4 illustrates a real-time method 4000 that report the physical size of payment accountholders when requested by a transportation provider 1350, constructed and operative in accordance with an embodiment of the present disclosure. In some embodiments, transportation provider 1350 may request traveler size information as part of the seat purchase process; in such an embodiment, method 4000 is used to provide the traveler size information to the transportation provider 1350.

At block 4010, seat matcher 2116 receives a traveler size request from a transportation provider 1350. The traveler size request contains Personally Identifiable Information (PII), such as a Primary Account Number or frequent flyer number associated with the traveler. The Primary Account Number may be received as part of the travel purchase process. In other embodiments, the Personally Identifiable Information may be any information about an individual maintained by an agency, including any information that can be used to distinguish or trace an individual's identity, such as name, government identification number, date and place of birth, mother's maiden name, frequent flyer number or biometric records that can uniquely identify the traveler. For the sake of example only, this disclosure will use the Primary Account Number.

At block 4020, seat matcher 2116 extracts traveler information (the PAN or other Personally Identifiable Information) from the traveler size request.

Using the PII, the traveler is matched with a size entry in the sizing database 2210, block 4030.

The network interface 2300 reports the traveler size to the transportation provider 1350 at block 4040.

FIG. 5 illustrates an alternate method of reporting the physical size of payment accountholders during a clearing process, constructed and operative in accordance with an embodiment of the present disclosure.

At block 5010, seat matcher 2116 receives purchase transaction data from a transportation provider 1350. The purchase transaction data contains a Primary Account Number associated with the traveler. The Primary Account Number may be received as part of the travel purchase process. In a clearing process, the travel provider 1350 embeds travel information (such as a travel itinerary) in addenda, identifying the transaction as a travel transaction. The addenda, in turn, may be supplemented by a Global Distribution System (GDS) database or Billing Service Provider (BSP) information. A Global Distribution System is a network that enables automated transactions between third parties and booking agents in order to provide travel-related services to end consumers. A GDS can link services, rates and bookings consolidating products and services across airline reservations, hotel reservations, car rentals and activities. Billing Service Provider (BSP) information is a unique location code identifying a specific travel agency.

The airline seat optimizer 2110 analyzes the transaction addenda and determines whether the purchase transaction is a travel transaction, block 5020. If so, process 5000 continues at block 5030.

At block 5030, the seat matcher 2116 identifies the traveling accountholder via the Primary Account Number, and checks if there is a size entry associated with the accountholder in the sizing database 2210. If there is a size entry, the accountholder size entry is retrieved, block 5040, and reported to the transportation provider 1350, block 5050.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method of estimating passenger size, the method comprising:
receiving, with a network interface, transaction data from a merchant bank, the transaction data including a primary account number (PAN) associated with a customer and addenda for the transaction data, the addenda describing an apparel purchase, the addenda including apparel detail;
extracting, with a processor, the primary account number from the transaction detail and the apparel detail from the addenda;
matching, with the processor, the primary account number with account information stored in a database, the database being encoded on a non-transitory computer-readable storage medium;
estimating, with the processor, a physical size of an individual associated with the primary account number based on the apparel detail;
storing, in the database, the physical size of the individual associated with the primary account number in the account information.

2. The processing method of claim 1, wherein the apparel detail contains a Stock Keeping Unit (SKU).

3. The processing method of claim 2, further comprising:
determining, with the processor, a type of apparel and a clothing size associated with the Stock Keeping Unit.

4. The processing method of claim 3, wherein estimating a physical size includes determining approximate height, weight, or width of the individual.

5. The processing method of claim 4, wherein there are multiple household members living with the customer.

6. The processing method of claim 5, wherein the physical size of the individual is associated with one of the multiple household members.

7. The processing method of claim 6, further comprising:
transmitting, with the network interface, the physical size of the individual to a travel provider.

8. A real-time system of generating a white list for anticipated future travel, the system comprising:
a network interface configured to receive transaction data from a merchant bank, the transaction data including a primary account number (PAN) associated with a customer and addenda for the transaction data, the addenda describing an apparel purchase, the addenda including apparel detail;
a processor configured to extract the primary account number from the transaction detail and the apparel detail from the addenda, to match the primary account number with account information stored in a database, the database being encoded on a non-transitory computer-readable storage medium, configured to estimate a physical size of an individual associated with the primary account number based on the apparel detail;
a non-transitory computer-readable storage medium with a database configured to store the physical size of the individual associated with the primary account number in the account information.

9. The system of claim 8, wherein the apparel detail contains a Stock Keeping Unit (SKU).

10. The system of claim 9, wherein the processor is further configured to determine a type of apparel and a clothing size associated with the Stock Keeping Unit.

11. The system of claim 10, wherein estimating a physical size includes determining approximate height, weight, or width of the individual.

12. The system of claim 11, wherein there are multiple household members living with the customer.

13. The system of claim 12, wherein the physical size of the individual is associated with one of the multiple household members.

14. The system of claim 13, wherein the network interface is further configured to transmit the physical size of the individual to a travel provider.

15. A non-transitory computer readable medium encoded with data and instructions, when executed by a computing device the instructions causing the computing device to:
receive, with a network interface, transaction data from a merchant bank, the transaction data including a primary account number (PAN) associated with a customer and addenda for the transaction data, the addenda describing an apparel purchase, the addenda including apparel detail;
extract, with a processor, the primary account number from the transaction detail and the apparel detail from the addenda;
match, with the processor, the primary account number with account information stored in a database, the database being encoded on a non-transitory computer-readable storage medium;
estimate, with the processor, a physical size of an individual associated with the primary account number based on the apparel detail;
store, in the database, the physical size of the individual associated with the primary account number in the account information.

16. The non-transitory computer-readable medium of claim 15, wherein the apparel detail contains a Stock Keeping Unit (SKU).

17. The non-transitory computer-readable medium of claim 16, the instructions further causing the computing device to:
determine, with the processor, a type of apparel and a clothing size associated with the Stock Keeping Unit.

18. The non-transitory computer-readable medium of claim 17, wherein estimating a physical size includes determining approximate height, weight, or width of the individual.

19. The non-transitory computer-readable medium of claim 18, wherein there are multiple household members living with the customer.

20. The non-transitory computer-readable medium of claim 19, wherein the physical size of the individual is associated with one of the multiple household members.
